(19) United States
(12) Patent Application Publication
(10) Pub. No.: US 2014/0250150 A1
(43) Pub. Date: Sep. 4, 2014

(54) METHOD AND APPARATUS FOR SEARCHING PATTERN OF SEQUENCE DATA

(71) Applicant: SAMSUNG ELECTRONICS CO., LTD., Suwon-si (KR)

(72) Inventors: Yo-Han ROH, Hwaseong-si (KR); Hyoung-Min PARK, Seoul (KR); Kyoung-Gu WOO, Seoul (KR); Joo-Hyuk JEON, Seoul (KR); Seok-Jin HONG, Hwaseong-si (KR)

(73) Assignee: SAMSUNG ELECTRONICS CO., LTD., Suwon-si (KR)

(21) Appl. No.: 14/196,114

(22) Filed: Mar. 4, 2014

(30) Foreign Application Priority Data
Mar. 4, 2013 (KR) 10-2013-0022972

(51) Int. Cl. G06F 17/30

(52) U.S. Cl. CPC G06F 17/30539
USPC 707/776

(57) ABSTRACT

A method of searching a pattern of sequence data, includes setting an interest pattern model comprising a length of an interest pattern, a value of an allowed mismatch, and a minimum support, obtaining supports of similar patterns of a child pattern, each of the similar patterns having a mismatch value with the child pattern that is greater than the value of the allowed mismatch, based on mismatch values of similar patterns of a parent pattern, and determining whether a support of the child pattern fulfills a condition of the minimum support based on the supports of the similar patterns of the child pattern, and a support of the parent pattern.

### CROSS-REFERENCE TO RELATED APPLICATION

This application claims the benefit under 35 USC 119(a) of Korean Patent Application No. 10-2013-0022972, filed on Mar. 4, 2013, in the Korean Intellectual Property Office, the entire disclosure of which is incorporated herein by reference for all purposes.

### BACKGROUND

1. Field

The following description relates to a method and apparatus for searching a pattern of sequence data.

2. Description of Related Art

Searching a pattern defines a form of an interest pattern, and extracts an interest pattern generated from sequence data. The searched interest pattern can be used in various data mining technologies, such as data classification and clustering, and also used in various application fields, such as bio, medical, and IT industries.

In addition, in pattern searching, a model of an interest pattern that defines its form can be used. That is, a pattern that fulfills the conditions of the interest pattern model can be searched using a length of the interest pattern, a value of an allowed mismatch, and a minimum support, which are included in the interest pattern model.

However, as sequence data size continuously increases, due to a rapid development of sensor devices and data acquisition technologies, a large amount of time and large computations are required to search for candidate patterns. An effective search method is required if the interest pattern model has various values of the allowed mismatch and minimum support, causing a number of times for searching a support to sharply increase.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of searching a pattern of sequence data, the method including setting an interest pattern model including a length of an interest pattern, a value of an allowed mismatch, and a minimum support, and obtaining supports of similar patterns of a child pattern, each of the similar patterns having a mismatch value with the child pattern that is greater than the value of the allowed mismatch, based on mismatch values of similar patterns of a parent pattern, and determining whether a support of the child pattern fulfills a condition of the minimum support based on the supports of the similar patterns of the child pattern, and a support of the parent pattern.

The determining of whether the support of the child pattern fulfills the condition may include determining whether a value obtained based on subtracting a sum of the supports of the similar patterns of the child pattern, from the support of the parent pattern, is greater than or equal to the minimum support.

The obtaining of the supports of the similar patterns may include obtaining a set of the similar patterns of the child pattern by appending a unit pattern that is different from a unit pattern that has been appended to the child pattern, to each of similar patterns of the parent pattern that has the mismatch value with the parent pattern that is identical to the value of the allowed mismatch, and obtaining the supports of the similar patterns of the child pattern that are included in the set.

The determining of whether the support of the child pattern fulfills the condition may include determining whether a sum of the supports of the similar patterns of the child pattern that are included in the set is greater than a value obtained based on subtracting the minimum support from the support of the parent pattern.

The obtaining of the supports of the similar patterns of the child pattern may include obtaining the supports of the similar patterns of the child pattern by appending a unit pattern that is the same as a unit pattern that has been appended to the child pattern, to each of similar patterns of the parent pattern that has the mismatch value with the parent pattern that is identical to the value of the allowed mismatch, and subtracting the supports of the similar patterns of the child pattern, from supports of the similar patterns of the parent pattern.

The determining of whether the support of the child pattern fulfills the condition may include determining whether a value obtained based on subtracting the supports of the similar patterns of the child pattern from the supports of the similar patterns of the parent pattern, is greater than a value obtained based on subtracting the minimum support from the support of the parent pattern.

The method may further include in response to the support of the child pattern being greater than or equal to the minimum support, and a length of the child pattern being less than the length of the interest pattern, determining whether grandchild patterns, which are derived from the child pattern, fulfill the condition based on the support of the child pattern and mismatch values of the similar patterns of the child pattern.

The obtaining of the supports of the similar patterns of the child pattern may include obtaining the supports of the similar patterns of the child pattern, using a data structure to search for the support, the data structure being generated in advance from the sequence data.

The data structure may include a suffix tree.

In another general aspect, there is provided an apparatus configured to search a pattern of sequence data, the apparatus including an interest pattern model setter configured to set an interest pattern model including a length of an interest pattern, a value of an allowed mismatch, and a minimum support, a support calculator configured to obtain supports of similar patterns of a child pattern, each of the similar patterns having a mismatch value with the child pattern that is greater than the value of the allowed mismatch, based on mismatch values of similar patterns of a parent pattern, and a determiner configured to determine whether a support of the child pattern fulfills a condition of the minimum support based on the supports of the similar patterns of the child pattern, and a support of the parent pattern.

The determiner may be configured to determine whether a value obtained based on subtracting a sum of the supports of the similar patterns of the child pattern, from the support of the parent pattern, is greater than or equal to the minimum support.

The support calculator may be configured to obtain a set of the similar patterns of the child pattern by appending a unit pattern that is different from a unit pattern that has been appended to the child pattern, to each of similar patterns of the parent pattern that has the mismatch value with the parent pattern that is identical to the value of the allowed mismatch, and obtain the supports of the similar patterns of the child pattern that are included in the set.

The determiner may be configured to determine whether a sum of the supports of the similar patterns of the child pattern that are included in the set is greater than a value obtained based on subtracting the minimum support from the support of the parent pattern.

The support calculator may be configured to obtain the supports of the similar patterns of the child pattern by appending a unit pattern that is the same as a unit pattern that has been appended to the child pattern, to each of similar patterns of the parent pattern that has the mismatch value with the parent pattern that is identical to the value of the allowed mismatch, and subtract the supports of the similar patterns of the child pattern, from supports of the similar patterns of the parent pattern.

The determiner may be configured to determine whether a value obtained based on subtracting the supports of the similar patterns of the child pattern from the supports of the similar patterns of the parent pattern, is greater than a value obtained based on subtracting the minimum support from the support of the parent pattern.

The determiner may be configured to in response to the support of the child pattern being greater than or equal to the minimum support, and a length of the child pattern being less than the length of the interest pattern, determine whether grandchild patterns, which are derived from the child pattern, fulfill the condition based on the support of the child pattern and mismatch values of the similar patterns of the child pattern.

The apparatus may further include a storage configured to store the support of the parent pattern, and the mismatch values.

The storage may be configured to in response to the support of the child pattern being greater than or equal to the minimum support, and the length of the child pattern being less than the length of the interest pattern, store the support of the child pattern and mismatch values of the similar patterns of the child pattern.

The support calculator may be configured to obtain the supports of the similar patterns of the child pattern, using a data structure to search for the support, the data structure being generated in advance from the sequence data.

In still another general aspect, there is provided an apparatus including a processor configured to calculate supports of similar patterns of a child pattern, each of the similar patterns having a mismatch value with the child pattern that is greater than a predetermined mismatch value, based on mismatch values of similar patterns of a parent pattern, and determine whether a support of the child pattern is greater than or equal to a predetermined minimum support based on the supports of the similar patterns of the child pattern, and a support of the parent pattern.

The processor may be configured to obtain the similar patterns of the child pattern by appending a unit pattern that is different from a unit pattern that has been appended to the child pattern, to each of similar patterns of the parent pattern that has the mismatch value with the parent pattern that is identical to the predetermined mismatch value, and determine whether a sum of the supports of the similar patterns of the child pattern is greater than a value of subtracting the minimum support from the support of the parent pattern.

The processor may be configured to obtain the similar patterns of the child pattern by appending a unit pattern that is the same as a unit pattern that has been appended to the child pattern, to each of similar patterns of the parent pattern that has the mismatch value with the parent pattern that is identical to the predetermined mismatch value, and determine whether a value of subtracting the supports of the similar patterns of the child pattern from supports of the similar patterns of the parent pattern, is greater than a value of subtracting the minimum support from the support of the parent pattern.

Other features and aspects will be apparent from the following detailed description, the drawings, and the claims.

### BRIEF DESCRIPTION OF THE DRAWINGS

FIG. 1 is a diagram illustrating an example of sequence data.

FIG. 2 is a diagram illustrating an example of candidate patterns.

FIG. 3 is a flowchart illustrating an example of a method of searching patterns of sequence data.

FIG. 4 is a diagram illustrating an example of a method of calculating supports of child patterns.

FIGS. 5 and 6 are flowcharts illustrating an example of a method of determining supports of similar patterns of a child pattern, each of the similar patterns having a mismatch value with the child pattern that is greater than an allowed mismatch value.

FIG. 7 is a diagram illustrating an example of an apparatus that searches for a pattern of sequence data.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

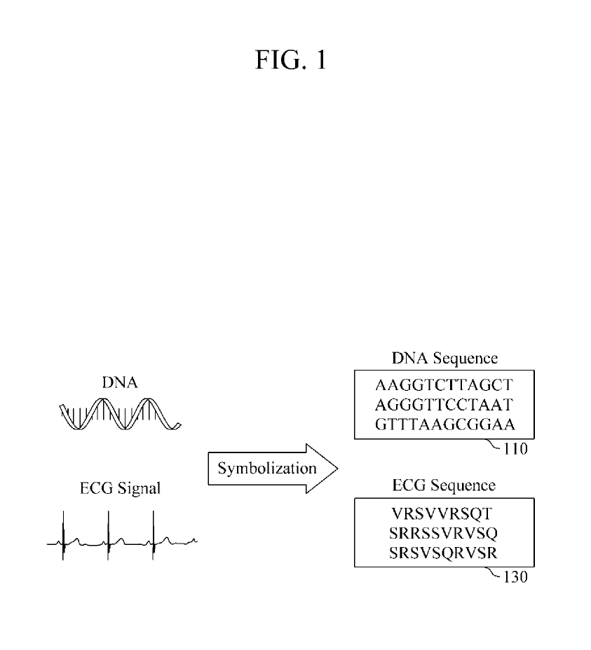

FIG. 1 is a diagram illustrating an example of sequence data. Referring to FIG. 1, the sequence data represents pieces of data that are arranged based on predetermined rules with respect to successive events. For example, the sequence data may be pieces of data arranged in order, such as a DNA sequence data 110 composed of bases A, G, C, and T as illustrated in FIG. 1. In another example, the sequence data may be pieces of data successively arranged in order, such as an electrocardiogram (ECG) sequence 130 that includes data measured from an electrocardiogram with expressible symbols. However, the sequence data is not limited to the examples illustrated here, which may be shown in various forms, such as words, characters, and/or numbers.

A unit pattern represents the shortest unit included in the sequence data. For example, the unit pattern of the DNA sequence data 110 indicates one of A, G, T, and C. A pattern represents a combination of successive unit patterns. Hereafter, the sequence data, pattern, and unit pattern are regarded as identical in meaning.

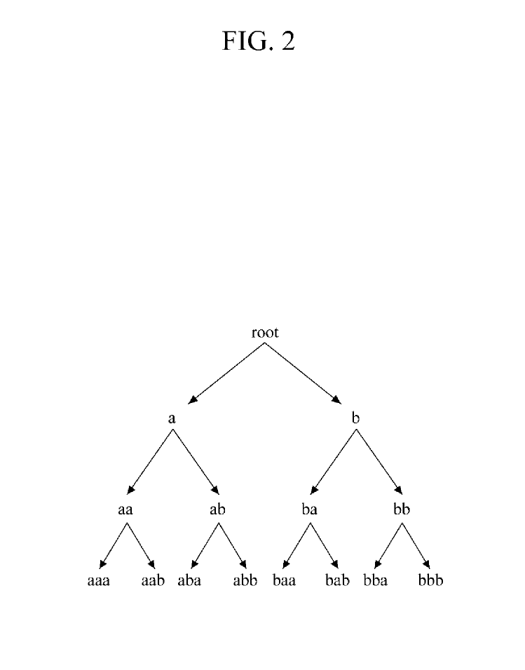

FIG. 2 is a diagram illustrating an example of candidate patterns. In this example, sequence data is composed of at least one unit pattern a or b. For a model of an interest pattern whose length is 3 digits, all of the generable candidate patterns are shown in FIG. 2. In other words, each of the candidate patterns has a length less than or equal to 3 digits, and may be generated as a combination of available unit patterns a and b.

Whether the candidate patterns fulfill conditions of the interest pattern model may be determined sequentially from the shortest parent pattern a or b to child patterns. In this example, the child pattern refers a pattern generated after a unit pattern is appended to a parent pattern. For example, as illustrated in FIG. 2, child patterns of ‘a’ are ‘aa’ and ‘ab’, and child patterns of ‘aa’ are ‘aaa’ and ‘aab’. Conversely, ‘a’ is a parent pattern of ‘aa’ and ‘ab’, and ‘aa’ is a parent pattern of ‘aaa’ and ‘aab’. Also, ‘aaa’, ‘aab’, ‘aba’, and ‘abb’ are grandchild patterns of ‘a’, and ‘baa’, ‘bab’, ‘bba’, and ‘bbb’ are the grandchild patterns of ‘b’. Hereafter, the parent pattern and the child pattern are regarded as the above-mentioned.

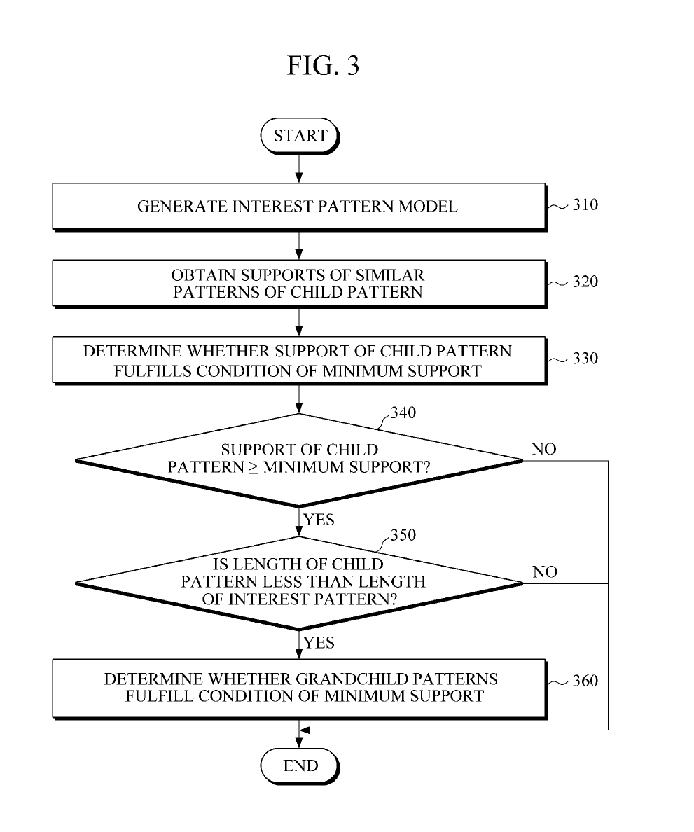

FIG. 3 is a flowchart illustrating an example of a method of searching patterns of sequence data. In operation 310, an interest pattern model including a length of an interest pattern, an allowed mismatch value, and a minimum support is generated.

Interest patterns are patterns, each having a support greater than a minimum support considering the allowed mismatch value of the interest pattern model, and fulfilling a condition of the interest pattern length. The support indicates how many times the corresponding pattern is shown in sequence data, and the minimum support indicates the lowest support needed for the patterns to be the interest patterns. In calculating the support of the corresponding pattern in the sequence data, the mismatch value is used to consider patterns that are not entirely the same but similar with the corresponding pattern, and overcome noise that may be generated in a process of acquiring the sequence data. For example, pattern ‘ABAAAC’ has the mismatch value of 1 compared to a pattern ‘ABBAAC’, and ‘AAAAAC’ has the mismatch value of 2 compared to the pattern ‘ABBAAC’.

Accordingly, the support of the corresponding pattern is obtained by considering the value of the allowed mismatch. For example, if the allowed mismatch value of the interest pattern model is 2, the support of the corresponding pattern represents a sum of supports of similar patterns, each having a mismatch value of less than 2 compared to the corresponding pattern.

The interest pattern model may be set by a user. For example, where exact forms of meaningful patterns are known in the sequence data in advance, the user may set the length of the interest patterns, the allowed mismatch value, and the minimum support, and therefore, may set the interest pattern model. Where approximate forms of the meaningful patterns are known, the user may set a plurality of interest pattern models, each having at least one different value of the length, the allowed mismatch value, and the minimum support, with respect to the interest patterns.

In operation 320, supports of similar patterns of a child pattern, each of the similar patterns having a mismatch value with the child pattern that is greater than the allowed mismatch value, is obtained, using information of mismatch values of similar patterns of a parent pattern, which will be described later in detail. The supports of the similar patterns of the child pattern may be determined based on a data structure that is used to search for a support, which has already been acquired from the sequence data in advance. The data structure to be used to search for the support may be generated in advance and stored in storage media, such as a memory or disk, if the sequence data is input.

In addition, the data structure to be used to search for the support may use a suffix tree. For example, if the sequence data is composed of a combination of unit patterns a and b, the suffix tree may provide information of supports of all available patterns starting with the unit pattern a or b. That is, if the suffix tree to be used to search for the support of the sequence data has been generated and stored in advance in the storage media, the supports of the patterns may be immediately obtained by using path information of the suffix tree.

However, the data structure to be used to search for the support is not limited to the suffix tree. Various forms of data structures may be used, such as a hash table and/or other data structures known to one of ordinary skill in the art.

In operation 330, whether a support of the child pattern fulfills a condition of the minimum support of the interest pattern model is determined based on the supports of the similar patterns of the child pattern, each having the mismatch value with the child pattern that is greater than the allowed mismatch value, and a support of a parent pattern. The support of the child pattern may be determined by subtracting a sum of the supports of the similar patterns of the child pattern, each having the mismatch value with the child pattern that is greater than the allowed mismatch value, from the support of the parent pattern.

In other words, the child pattern is a pattern generated after a unit pattern is appended to the parent pattern, so the support of the child pattern may not be greater than the support of the parent pattern. To calculate the support of the child pattern, the supports of the similar patterns of the child pattern, each having the mismatch value with the child pattern that is greater than the allowed mismatch value, may be excluded. Thus, the support of the child pattern may be identical to a resulting value obtained after subtracting the sum of the supports of the similar patterns of the child pattern, each having the mismatch value with the child pattern that is greater than the allowed mismatch value, from the support of the parent pattern.

In operation 340, it is determined whether the support of the child pattern is greater than or equal to the minimum support. When the support of the child pattern is determined to be greater than or equal to the minimum support, the method continues in operation 350. Otherwise, the method ends.

In operation 350, it is determined whether a length of the child pattern is less than the length of the interest pattern. When the length of the child pattern is determined to be less than the length of the interest pattern, the method continues in operation 360. Otherwise, the method ends.

In operation 360, it is determined whether grandchild patterns derived from the child pattern fulfill the condition of the minimum support. The determination of whether the grandchild patterns fulfill the condition of the minimum support may be determined based on information, such as the support of the child pattern and mismatch values of the similar patterns of the child pattern, and also may be determined through the same process of determining whether the child pattern fulfills the condition of the minimum support.

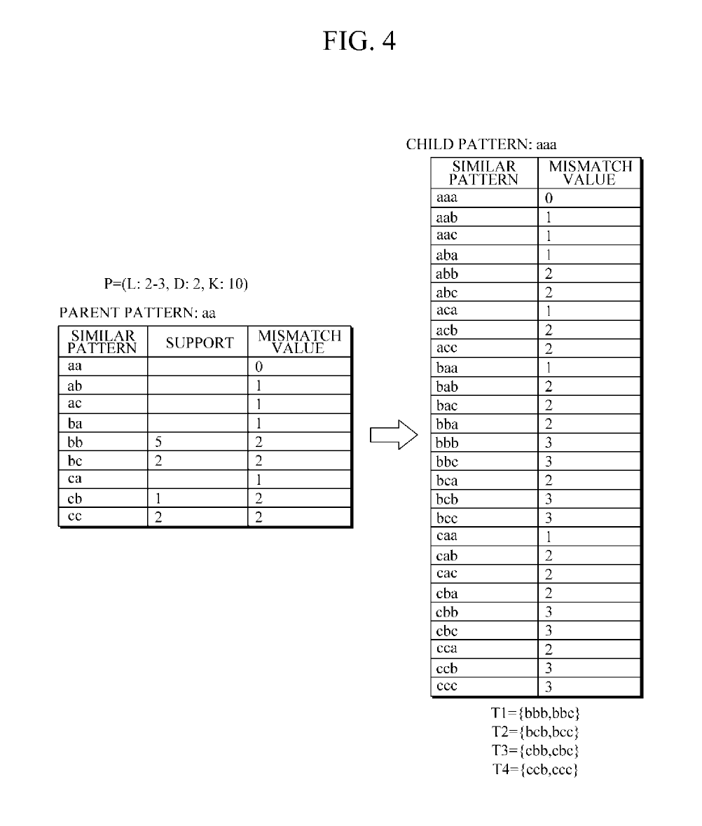

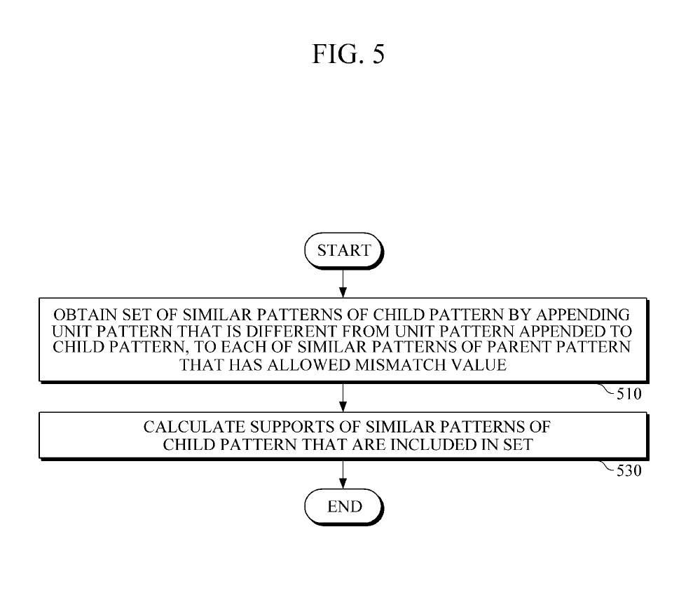

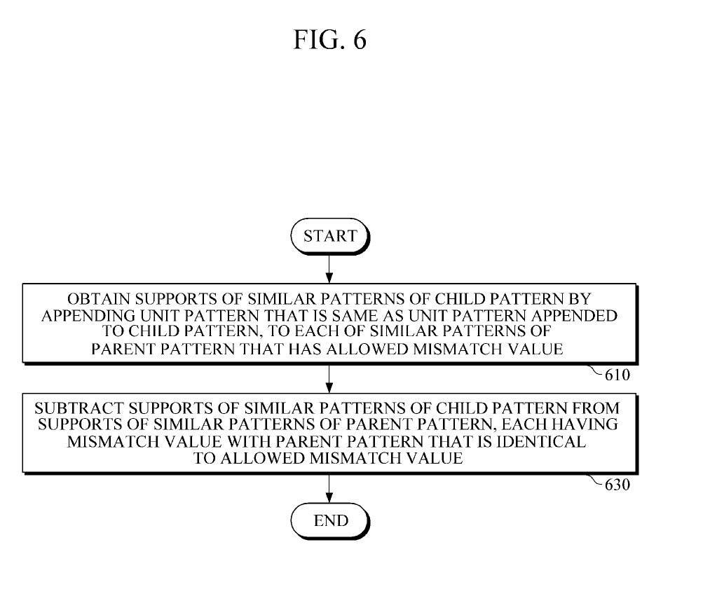

FIG. 4 is a diagram illustrating an example of a method of calculating supports of child patterns. Also, FIGS. 5 and 6 are flowcharts illustrating an example of a method of determining supports of similar patterns of a child pattern, each of the similar patterns having a mismatch value with the child pattern that is greater than an allowed mismatch value.

Referring to FIG. 4, an interest pattern model is set as P=(L: 2-3, D: 2, K: 10), where available unit patterns are ‘a’, ‘b’, and ‘c’. In this example, L represents a length of an interest pattern, D represents an allowed mismatch value, and K represents a minimum support.

Referring to FIG. 5, in operation 510, a set of the similar patterns of the child pattern is obtained by appending a unit pattern that is different from a unit pattern that has already been appended to the child pattern, to each of similar patterns of a parent pattern that has a mismatch value with the parent pattern that is identical to the allowed mismatch value.

In operation 530, the supports of the similar patterns of the child pattern that are included in the set are calculated. After those operations, the supports of the similar patterns of the child pattern, each having a mismatch value with the child pattern that is greater than the allowed mismatch value, is calculated.

Referring again to FIG. 4, similar patterns of child pattern ‘aaa’, which are included in sets T1 to T4, and each having a mismatch value with the child pattern ‘aaa’ that is greater than the allowed mismatch value (2), are obtained by appending a unit pattern ‘b’ or ‘c’ that is different from a unit pattern ‘a’ appended to the child pattern to each similar pattern (‘bb’, ‘bc’, ‘cb’, and ‘cc’), among similar patterns of parent pattern ‘aa’, which has a mismatch value (2) with the parent pattern that is identical to the allowed mismatch value (2). Mismatch values of the similar patterns of the parent pattern ‘aa’, except for ‘bb’, ‘bc’, ‘cb’, and ‘cc’, are less than the allowed mismatch value (2). So if any unit pattern is appended to the similar patterns of the parent pattern ‘aa’, except for ‘bb’, ‘bc’, ‘cb’, and ‘cc’, each of mismatch values of the resulting child patterns may not be greater than the allowed mismatch value. Thus, the similar patterns of the child pattern ‘aaa’ that eachhave the mismatch value with the child pattern ‘aaa’ that is greater than the allowed mismatch value (2), are the same as the similar patterns ‘bbb’, ‘bbc’, ‘bcb’, ‘bcc’, ‘cbb’, ‘cbc’, ‘ccb’, and ‘ccc’ included in the sets T1 to T4.

Through the method in FIG. 4, a support of the child pattern ‘aaa’ may be obtained by Equation 1.

Sₐₐₐ=Sₐₐ−[f(bb)+f(bc)+f(cb)+f(cc)] (1)

In Equation 1, Saaa and Saa represent supports of the child pattern ‘aaa’ and the parent pattern ‘aa’, respectively, f(bb) represents a support sum of the similar patterns ‘bbb’ and ‘bbc’, f(bc) represents a support sum of the similar patterns ‘bcb’ and ‘bcc’, f(cb) represents a support sum of the similar patterns ‘cbb’ and ‘cbc’, and f(cc) represents a support sum of the similar patterns ‘ccb’ and ‘ccc’.

In other words, it is acceptable to not obtain supports of all of the similar patterns of the child pattern ‘aaa’, but the supports of only the parent pattern ‘aa’ and the similar patterns included in the sets T1 to T4, to obtain the support of the child pattern ‘aaa’. Thus, a number of support searches needed for a relatively large calculation, may be reduced. Also, the support of the child pattern ‘aaa’ is obtained based on only the support of the parent pattern ‘aa’, and the supports of the similar patterns included in the sets T1 to T4, so data kept in memory can be minimized. In addition, Equation 2 should also be satisfied so that the support of the child pattern ‘aaa’ can fulfill a condition of the minimum support.

Sₐₐₐ=Sₐₐ−[f(bb)+f(bc)+f(cb)+f(cc)]≧K (2)

In Equation 2, K represents the minimum support.

Equation 2 can also be represented as Equation 3 below.

Sₐₐ−K≧[f(bb)+f(bc)+f(cb)+f(cc)] (3)

Referring to Equations 2 and 3 again, a sum of the sum supports f(bb), f(bc), f(cb), and f(cc) should be less than or equal to a value obtained after subtracting the minimum support K from the support of the parent pattern ‘aa’ so that the support of the child pattern ‘aaa’ can fulfill the condition of the minimum support. Thus, if at least one of f(bb), f(bc), f(cb), and f(cc) is greater than the value obtained after subtracting the minimum support K from the support of the parent pattern ‘aa’, the support of the child pattern ‘aaa’ is less than the minimum support. That is, if at least one of f(bb), f(bc), f(cb), and f(cc) is greater than the value obtained after subtracting the minimum support K from the support of the parent pattern ‘aa’, it may be determined that the child pattern ‘aaa’ does not fulfill the condition of the minimum support.

For example, as illustrated in FIG. 4, if the support of the parent pattern ‘aa’ is 12 and the support sum f(bb) of the similar patterns ‘bbb’ and ‘bbc’ is 4, the support sum f(bb) (4) is greater than the value (2) obtained after subtracting the minimum support (10) from the support (12) of the parent pattern ‘aa’. It may be determined that the child pattern ‘aaa’ does not fulfill the minimum support condition. In this example, the support sums f(bc), f(cb), and f(cc) do not need to be calculated, so a support search for the similar patterns included in the sets T2 to T4 is not required.

In another example, referring to FIG. 6, in operation 610, the supports of the similar patterns of the child pattern are obtained by appending the unit pattern that is the same as a unit pattern that has already been appended to the child pattern, to each of the similar patterns of the parent pattern that has the mismatch value with the parent pattern that is identical to the allowed mismatch value.

In operation 630, the supports of the similar patterns of the child pattern are subtracted from supports of the similar patterns of the parent pattern, each of the similar patterns of the parent pattern having the mismatch value with the parent pattern that is identical to the allowed mismatch value. After those operations, the supports of the similar patterns of the child pattern, each of the similar patterns of the child pattern having the mismatch value with the child pattern that is greater than the allowed mismatch value, is obtained.

As illustrated in FIG. 4, a support of the similar pattern ‘bb’ whose mismatch value with the parent pattern ‘aa’ is identical to the allowed mismatch value, among similar patterns of the parent pattern ‘aa’, is equal to a sum of supports of similar patterns ‘bba’, ‘bbb’, and ‘bbc’, which are included in similar patterns of the child pattern ‘aaa’. Thus, a sum of the supports of the similar patterns ‘bbb’ and ‘bbc’ is equal to a value obtained after subtracting the support of the similar pattern ‘bba’ from the support of the similar pattern ‘bb’.

That is, the sum support f(bb) is equal to the value obtained after subtracting the support of the similar pattern ‘bba’, which is the similar pattern of the child pattern ‘aaa’, from the support of the similar pattern ‘bb’, which is the similar pattern of the parent pattern ‘aa’, in Equation 1. Consequently, only supports of the similar patterns ‘bba’, ‘bca’, ‘cba’, and ‘cca’ among the similar patterns of the child pattern ‘aaa’ are needed to determine the sum supports f(bb), f(bc), f(cb), and f(cc), respectively, so the number of support searches may be minimized.

If at least one of the sum supports f(bb), f(bc), f(cb), and f(cc) is greater than a value obtained after subtracting the minimum support from the support of the parent pattern ‘aa’, it may be determined that the child pattern ‘aaa’ does not fulfill the minimum support condition. For example, referring to FIG. 4, if the support of the parent pattern ‘aa’ is 12, the minimum support is 10, the support of the similar pattern ‘bb’ is 5, and the support of the similar pattern ‘bba’ is 1, the sum support f(bb) (4) is greater than the value (2) obtained after subtracting the minimum support (10) from the support (12) of the parent pattern ‘aa’. Thus, it is determined that the child pattern ‘aaa’ does not fulfill the minimum support condition. Also, the sum supports f(bc), f(cb), and f(cc) do not need to be determined, so a support search of the similar patterns ‘bca’, ‘cba’, and ‘cca’ is not needed.

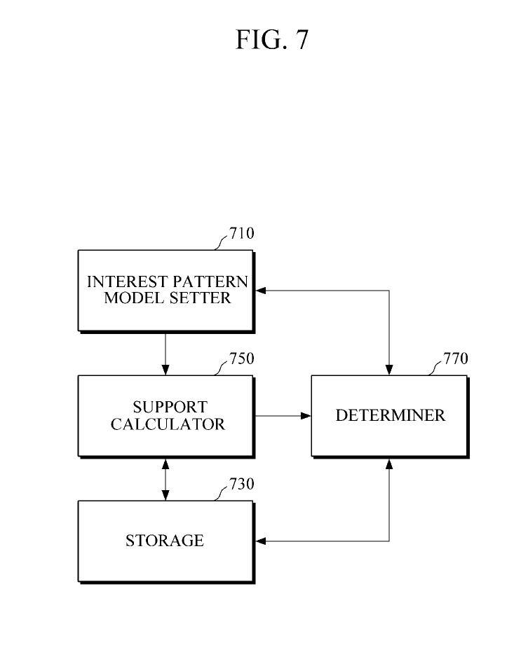

FIG. 7 is a diagram illustrating an example of an apparatus that searches for a pattern of sequence data. Referring to FIG. 7, the apparatus that searches for the pattern of the sequence data includes an interest pattern model setter 710, storage 730, a support calculator 750, and a determiner 770.

An interest pattern model setter 710 sets an interest pattern model including an interest pattern length, an allowed mismatch value, and a minimum support. The interest pattern model setter 710 may receive, from a user, input of the interest pattern length, the allowed mismatch value, and the minimum support, and set the interest pattern model based on the input.

The storage 730 stores information of a support and a mismatch value of a parent pattern that is needed to determine whether a support of a child pattern fulfills a condition of the minimum support. The information of the support and the mismatch value of the parent pattern may include the support and the mismatch value of the parent pattern, and supports of similar patterns of the parent pattern, each of the similar patterns of the parent pattern having a mismatch value with the parent pattern that is identical to the allowed mismatch value.

The support calculator 750 calculates supports of similar patterns of the child pattern, each of the similar patterns of the child pattern having a mismatch value with the child pattern that is greater than the allowed mismatch value, based on the mismatch values of the similar patterns of the parent pattern. Also, the support calculator 750 sets the supports of the similar patterns of the child pattern in a data structure to be used to search for the support, which is generated in advance from the sequence data. The data structure to be used to search for the support may be in various forms, such as a suffix tree or a hash table.

For example, the support calculator 750 may obtain a set of the similar patterns of the child pattern, by appending a unit pattern different from a unit pattern that has been appended to the child pattern, to each of the similar patterns of the parent pattern that has the mismatch value with the parent pattern that is identical to the allowed mismatch value. Then, the supports of the similar patterns included in the set are calculated. Accordingly, the supports of the similar patterns of the child pattern, each of the similar patterns of the child pattern having the mismatch value with the child pattern that is greater than the allowed mismatch value, among the similar patterns of the child pattern, are obtained.

In another example, the support calculator 750 may obtain the supports of similar patterns of the child pattern by appending a unit pattern that is same as the unit pattern that has been appended to the child pattern, to each of the similar patterns of the parent pattern that has the mismatch value with the parent pattern that is identical to the allowed mismatch value. Then, the supports of the similar patterns of the child pattern are subtracted from supports of the similar patterns of the parent pattern, each of the similar patterns of the parent pattern having the mismatch value with the parent pattern that is identical to the allowed mismatch value, among the similar patterns of the parent pattern. Accordingly, the supports of the similar patterns of the child pattern, each of the similar patterns of the child pattern having the mismatch value with the child pattern that is greater than the allowed mismatch value, among the similar patterns of the child pattern, are obtained.

The determiner 770 determines whether the support of the child pattern fulfills the condition of the minimum support based on the supports of the similar patterns of the child pattern, each of the similar patterns of the child pattern having the mismatch value with the child pattern that is greater than the allowed mismatch value, and the support of the parent pattern. If a value obtained after subtracting a sum of the supports of the similar patterns of the child pattern, each of the similar patterns of the child pattern having the mismatch value with the child pattern that is greater than the allowed mismatch value, from the support of the parent pattern, is greater than or equal to the minimum support, it is determined that the support of the child pattern fulfills the condition of the minimum support.

When the similar patterns of the child pattern are formed by appending the unit pattern that is different from the unit pattern appended to the child pattern, to each of the similar patterns of the parent pattern that has the mismatch value with the parent pattern that is identical to the allowed mismatch value, and the support sum of the similar patterns of the child pattern is greater than a value obtained after subtracting the minimum support from the support of the parent pattern, it may be determined that the support of the child pattern does not fulfill the condition of the minimum support. Also, when the similar pattern of the child pattern is formed by appending the unit pattern that is identical to the unit pattern appended to the child pattern, to the similar pattern of the parent pattern that has the mismatch value with the parent pattern that is identical to the allowed mismatch value, and a value obtained after subtracting the support of the similar pattern of the child pattern from the support of the similar pattern of the parent pattern that has the mismatch value with the parent pattern that is identical to the allowed mismatch value, is greater than a value obtained after subtracting the minimum support from the support of the parent pattern, it may be determined that the support of the child pattern does not fulfill the condition of the minimum support.

If the support of the child pattern is greater than the minimum support, and the child pattern length is less than the interest pattern length, the determiner 770 determines whether any of the grandchild patterns fulfills the condition of the minimum support based on the support and the mismatch value of the child pattern. In this example, the storage 730 stores information of the support and the mismatch value of the child pattern.

The various units, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of searching a pattern of sequence data, the method comprising:
setting an interest pattern model comprising a length of an interest pattern, a value of an allowed mismatch, and a minimum support;
obtaining supports of similar patterns of a child pattern, each of the similar patterns having a mismatch value with the child pattern that is greater than the value of the allowed mismatch, based on mismatch values of similar patterns of a parent pattern; and
determining whether a support of the child pattern fulfills a condition of the minimum support based on the supports of the similar patterns of the child pattern, and a support of the parent pattern.

2. The method of claim 1, wherein the determining of whether the support of the child pattern fulfills the condition comprises:
determining whether a value obtained based on subtracting a sum of the supports of the similar patterns of the child pattern, from the support of the parent pattern, is greater than or equal to the minimum support.

3. The method of claim 1, wherein the obtaining of the supports of the similar patterns comprises:
obtaining a set of the similar patterns of the child pattern by appending a unit pattern that is different from a unit pattern that has been appended to the child pattern, to each of similar patterns of the parent pattern that has the mismatch value with the parent pattern that is identical to the value of the allowed mismatch; and
obtaining the supports of the similar patterns of the child pattern that are included in the set.

4. The method of claim 3, wherein the determining of whether the support of the child pattern fulfills the condition comprises:
determining whether a sum of the supports of the similar patterns of the child pattern that are included in the set is greater than a value obtained based on subtracting the minimum support from the support of the parent pattern.

5. The method of claim 1, wherein the obtaining of the supports of the similar patterns of the child pattern comprises:
obtaining the supports of the similar patterns of the child pattern by appending a unit pattern that is the same as a unit pattern that has been appended to the child pattern, to each of similar patterns of the parent pattern that has the mismatch value with the parent pattern that is identical to the value of the allowed mismatch; and
subtracting the supports of the similar patterns of the child pattern, from supports of the similar patterns of the parent pattern.

6. The method of claim 5, wherein the determining of whether the support of the child pattern fulfills the condition comprises:
determining whether a value obtained based on subtracting the supports of the similar patterns of the child pattern from the supports of the similar patterns of the parent pattern, is greater than a value obtained based on subtracting the minimum support from the support of the parent pattern.

7. The method of claim 1, further comprising:
in response to the support of the child pattern being greater than or equal to the minimum support, and a length of the child pattern being less than the length of the interest pattern, determining whether grandchild patterns, which are derived from the child pattern, fulfill the condition based on the support of the child pattern and mismatch values of the similar patterns of the child pattern.

8. The method of claim 1, wherein the obtaining of the supports of the similar patterns of the child pattern comprises:
obtaining the supports of the similar patterns of the child pattern, using a data structure to search for the support, the data structure being generated in advance from the sequence data.

9. The method of claim 8, wherein the data structure comprises a suffix tree.

10. An apparatus configured to search a pattern of sequence data, the apparatus comprising:
an interest pattern model setter configured to set an interest pattern model comprising a length of an interest pattern, a value of an allowed mismatch, and a minimum support;
a support calculator configured to obtain supports of similar patterns of a child pattern, each of the similar patterns having a mismatch value with the child pattern that is greater than the value of the allowed mismatch, based on mismatch values of similar patterns of a parent pattern; and
a determiner configured to determine whether a support of the child pattern fulfills a condition of the minimum support based on the supports of the similar patterns of the child pattern, and a support of the parent pattern.

11. The apparatus of claim 10, wherein the determiner is configured to:
determine whether a value obtained based on subtracting a sum of the supports of the similar patterns of the child pattern, from the support of the parent pattern, is greater than or equal to the minimum support.

12. The apparatus of claim 10, wherein the support calculator is configured to:
obtain a set of the similar patterns of the child pattern by appending a unit pattern that is different from a unit pattern that has been appended to the child pattern, to each of similar patterns of the parent pattern that has the mismatch value with the parent pattern that is identical to the value of the allowed mismatch; and
obtain the supports of the similar patterns of the child pattern that are included in the set.

13. The apparatus of claim 12, wherein the determiner is configured to:
determine whether a sum of the supports of the similar patterns of the child pattern that are included in the set is greater than a value obtained based on subtracting the minimum support from the support of the parent pattern.

14. The apparatus of claim 10, wherein the support calculator is configured to:
obtain the supports of the similar patterns of the child pattern by appending a unit pattern that is the same as a unit pattern that has been appended to the child pattern, to each of similar patterns of the parent pattern that has the mismatch value with the parent pattern that is identical to the value of the allowed mismatch; and
subtract the supports of the similar patterns of the child pattern, from supports of the similar patterns of the parent pattern.

15. The apparatus of claim 14, wherein the determiner is configured to:
determine whether a value obtained based on subtracting the supports of the similar patterns of the child pattern from the supports of the similar patterns of the parent pattern, is greater than a value obtained based on subtracting the minimum support from the support of the parent pattern.

16. The apparatus of claim 10, wherein the determiner is configured to:
in response to the support of the child pattern being greater than or equal to the minimum support, and a length of the child pattern being less than the length of the interest pattern, determine whether grandchild patterns, which are derived from the child pattern, fulfill the condition based on the support of the child pattern and mismatch values of the similar patterns of the child pattern.

17. The apparatus of claim 10, further comprising:
a storage configured to store the support of the parent pattern, and the mismatch values.

18. The apparatus of claim 17, wherein, the storage is configured to:
in response to the support of the child pattern being greater than or equal to the minimum support, and the length of the child pattern being less than the length of the interest pattern, store the support of the child pattern and mismatch values of the similar patterns of the child pattern.

19. The apparatus of claim 10, wherein the support calculator is configured to:
obtain the supports of the similar patterns of the child pattern, using a data structure to search for the support, the data structure being generated in advance from the sequence data.

20. The apparatus of claim 19, wherein the data structure comprises a suffix tree.

21. An apparatus comprising:
a processor configured to
calculate supports of similar patterns of a child pattern, each of the similar patterns having a mismatch value with the child pattern that is greater than a predetermined mismatch value, based on mismatch values of similar patterns of a parent pattern, and
determine whether a support of the child pattern is greater than or equal to a predetermined minimum support based on the supports of the similar patterns of the child pattern, and a support of the parent pattern.

22. The apparatus of claim 21, wherein the processor is configured to:
obtain the similar patterns of the child pattern by appending a unit pattern that is different from a unit pattern that has been appended to the child pattern, to each of similar patterns of the parent pattern that has the mismatch value with the parent pattern that is identical to the predetermined mismatch value; and
determine whether a sum of the supports of the similar patterns of the child pattern is greater than a value of subtracting the minimum support from the support of the parent pattern.

23. The apparatus of claim 21, wherein the processor is configured to:
obtain the similar patterns of the child pattern by appending a unit pattern that is the same as a unit pattern that has been appended to the child pattern, to each of similar patterns of the parent pattern that has the mismatch value with the parent pattern that is identical to the predetermined mismatch value; and
determine whether a value of subtracting the supports of the similar patterns of the child pattern from supports of the similar patterns of the parent pattern, is greater than a value of subtracting the minimum support from the support of the parent pattern.
